(19) United States
(12) Patent Application Publication
(10) Pub. No.: US 2020/0186002 A1
(43) Pub. Date: Jun. 11, 2020

(54) ROTOR AND ELECTRICAL MACHINE

(71) Applicant: Vitesco Technologies GMBH, Hannover (DE)

(72) Inventors: Holger Fröhlich, Berlin (DE); Nevzat Guener, Berlin (DE)

(73) Assignee: Vitesco Technologies GMBH, Hannover (DE)

(21) Appl. No.: 16/795,295

(22) Filed: Feb. 19, 2020

Related U.S. Application Data
(63) Continuation of application No. PCT/EP2018/071292, filed on Aug. 6, 2018.

(30) Foreign Application Priority Data
Aug. 21, 2017 (DE) 10 2017 214 555.2

(51) Int. Cl. H02K 5/24; H02K 1/28; H02K 5/173; H02K 7/00; H02K 7/08; G10K 11/162; B60R 13/08; B60K 1/00

(52) U.S. Cl. CPC H02K 5/24; H02K 1/28; H02K 5/1732; H02K 7/003; B60K 1/00; H02K 7/083; G10K 11/162; B60R 13/0838; H02K 7/006

(57) ABSTRACT

A rotor for an electric machine comprises at least one structure-borne sound absorbing element made of a cellular metallic material being arranged in the rotor. The electric machine comprises a rotor shaft, two roller bearings and a bearing seat for each one of the two roller bearings, the rotor shaft being rotatably mounted in the two roller bearings, and a structure-borne sound absorbing element made of a cellular metallic material being arranged in the region of at least one of the two bearing seats.

### CROSS-REFERENCE TO RELATED APPLICATION

This application claims the benefit of PCT Application PCT/EP2018/071292, filed Aug. 08, 2018, which claims priority to German Application DE 10 2017 214 555.2, filed Aug. 21, 2017. The disclosures of the above applications are incorporated herein by reference.

### TECHNICAL FIELD

The invention relates to a rotor for an electric machine. The invention also relates to an electric machine.

### BACKGROUND

One of the main causes of noises in an electric axle drive is typically the non-uniformity of the torque in an electric machine. The non-uniformity of the torque in the electric machine is dependent on the type of construction, and can be influenced by the design of the electric machine.

The most efficient way of reducing noise is to not allow the noise to be produced in the first place, or at least to reduce the sound already at its inception. There are various possible ways of identifying a source of sound. One approach is theoretical. In this case, the machine is imagined to be broken down into its individual components and then classified according to its mechanical-acoustic properties. The result of this investigation are evaluation tables for the sound sources, sound transmitters and sound emitters. They lead to a sound flow diagram that graphically illustrates which components of the machine must be dealt with first to reduce noise. The greater the influence of a source, or the more a body transmits or emits, the more necessary it is to intervene at this point. For this purpose, the components are marked according to the magnitude of their influence with lines of different thicknesses. The thicker such a line is, the more critical the effect on the noise is and the more necessary it is for noise reduction to be carried out here.

This type of analysis is suitable both for designs and for existing machines. It shows at which points the intervention of an acoustician is necessary and appropriate. If there are several highly prioritized sound sources in the sound flow diagram, this is not a problem during the design phase, as there are at this point still sufficient options for planning noise reduction measures.

Based on this, it is desirable to reduce the noises in an electric axle drive in an alternative and simple manner.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

At least one structure-borne sound absorbing element made of a cellular metallic material is arranged in a rotor and/or in the region of a bearing seat of an electric machine. Damping of vibrations can thus be achieved by design-related measures, joining measures or material-technical measures. The structure-borne sound absorbing element absorbs energy and contributes to improving the practical value of the electric machine.

Structure-borne sound damping may mean an absorption of the vibration energy by thermal, magnetic or atomic rearrangements of the molecules of the applied damping material. A parameter for the absorption of structure-borne sound is the so-called “loss factor”, which is a measure of the ability of the material concerned to absorb energy under dynamic stress, for example with bending vibrations. Suitable as materials for structure-borne sound damping for electric machines are cellular metallic materials, which allow great airborne sound damping and structure-borne sound damping and are therefore provide passive damping elements in the construction of the electric machine or the rotor for the electric machine.

A distinction can be made between force excitation and speed excitation in the components in an effect chain of a structure. Force-excited components are typically in a closed power flow and are excited to structure-borne vibrations by elastic deformations, for example a rotor and a rotor shaft of an electric machine (see the rotor for the electric machine according to the first aspect of the invention below). Speed-excited components, on the other hand, are outside a power flow. They are not load-bearing parts. However, they are coupled to components in the power flow and are caused to emit structure-borne vibrations via a coupling point for example the housing of an electric machine, e.g. in the region of bearings of a rotor shaft of the electric machine (see the electric machine according to the second aspect of the invention).

In practice, force-excited and speed-excited components can influence one another with regard to their structure-borne vibrations, which is why structure-borne sound should be hindered as much as possible from propagating within the structure. This can be achieved through structure-borne sound insulation and structure-borne sound damping.

In many cases, the avoidance of structure-borne sound propagation, which is desirable for noise abatement, cannot be achieved with the means for structure-borne sound insulation, because without damping the energy is not consumed.

A reduction in structure-borne sound transmission by damping requires great internal losses in the materials used. Structure-borne sound energy is converted into heat by friction on contact surfaces or by internal friction of the materials. Here, too, the structure-borne sound damping is more effective the closer it is to the point of inception, for example in the rotor or in the rotor shaft and close to the bearing of the rotor shaft.

In this sense, a rotor for an electric machine is provided according to a first embodiment. At least one structure-borne sound absorbing element, for example in the form of a shaped body, made of a cellular metallic material is arranged in the rotor.

In one embodiment, the rotor comprises a rotor shaft with a bore, the structure-borne sound absorbing element being arranged within the bore of the rotor shaft. The bore may be for example a central bore that extends in a longitudinal direction of the rotor shaft.

In a further embodiment, the rotor comprises a laminated rotor core with at least one slot, the structure-borne sound absorbing element being arranged in the slot of the laminated rotor core. The at least one slot may for example extend parallel to a longitudinal direction of the rotor shaft. A number of slots, which may be spaced equidistantly apart from one another in a circumferential direction, may be provided.

In a further embodiment, the rotor comprises a first shaft journal, a second shaft journal, a laminated rotor core and a carrier for the laminated rotor core, the carrier for the laminated rotor core being arranged between the first shaft journal and the second shaft journal. The carrier, the first shaft journal and the second shaft journal can delimit a cavity between them, and the structure-borne sound absorbing element may be arranged within the cavity.

The cellular metallic material may be a metal foam, for example an aluminum foam. The metal foam has structure-specific properties which make it possible to produce composite structures with improved rigidity, with a improved damping capacity and with the possibility of controlled energy absorption. Constructions with integrated aluminum foam are still light, absorb a lot of energy and dampen vibrations and noises effectively. The introduction or arrangement of the metal foam, for example the aluminum foam, in machine parts that are transmitters or emitters of structure-borne sound allow both lightweight construction and sound damping or vibration damping.

Furthermore, the metal foam may comprise hollow spherical structures. The hollow spherical structures may for example be metallic. The metal foam may be distinguished by the combination of open and closed porosity and the hollow spherical structures may be formed by spherical cells with precisely adjustable cell diameters and cell wall thicknesses.

The hollow spherical structures offer the possibility of using up vibrational energy. As soon as a wavefront reaches the hollow spherical shells, the spherical shells start to vibrate against one another. Vibration energy is converted by friction and partially elastic impacts into heat. Since, in the case of structure-borne sound damping, vibration energy is converted into heat by internal friction, one can also speak of “internal damping”. The hollow spherical structures allow a high level of structure-borne sound damping and vibration damping for rapidly moving machine parts, for example for the rotor of the electric machine, and under extreme conditions. The metallic hollow spherical structures can be manufactured by special technologies and further processed flexibly. They can for example be cast in, but also be connected by adhesive bonding, soldering or sintering.

In a development, freely movable ceramic particles may be present in the interior of the hollow spherical structures described above. In this sense, in a further embodiment the metal foam may comprise hollow spherical structures which are filled with particles, for example with ceramic particles. The particles may act as vibration dampers. Sintered individual spheres can be filled into the structure-borne sound absorbing element, for example in the form of a shaped body, and fixed there by adhesive bonding or soldering. Further processing of the shaped bodies or else of individual hollow spherical structures into sandwich structures or casting into polymers or metals is also possible. When a component with particle-filled hollow spherical structures is vibrated, the movement of the base material directs the energy into the particle bed. The particles are thrown off the cavity wall and thereby take over the vibration energy. The kinetic energy is converted into heat by impacts and friction of the particles. The damping values achieved in this way can be about ten times as high as those of aluminum foam of a comparable density, which may be used as a vibration-damping lightweight construction material (see further above).

According to a second aspect, an electric machine is provided. The electric machine comprises a rotor shaft, two roller bearings and a bearing seat for each one of the two roller bearings, the rotor shaft being rotatably mounted in the two roller bearings, and a structure-borne sound absorbing element made of a cellular metallic material being arranged in the region of at least one of the two bearing seats.

The cellular metallic material may be a metal foam, for example an aluminum foam. Furthermore, the metal foam may comprise hollow spherical structures. In a further embodiment, the metal foam comprises hollow spherical structures which are filled with particles, for example with ceramic particles. With respect to effects, advantages and more detailed configurations of the embodiments described in this paragraph, in order to avoid repetitions reference is made to the above statements in connection with the rotor according to the first aspect.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the preferred embodiment of the disclosure, are intended for purposes of illustration only and are not intended to limit the scope of the disclosure.

### BRIEF DESCRIPTION OF THE FIGURES

Exemplary embodiments of the invention will be discussed in more detail below on the basis of the partially schematic drawing. In the drawing:

FIG. 1 shows a partially sectioned representation of a known electric axle drive;

FIG. 2 shows a longitudinal sectional representation of a known rotor with a rotor shaft and with a laminated rotor core;

FIG. 3 and FIG. 4 an show a longitudinal sectional representation of exemplary embodiment of a rotor according to the invention with a structure-borne sound absorbing metal foam integrated in a rotor shaft;

FIG. 5 shows a longitudinal sectional representation of a known rotor with a multi-part rotor shaft;

FIG. 6 and FIG. 7 show a longitudinal sectional representation of an exemplary embodiment of a rotor according to the invention with a structure-borne sound absorbing metal foam integrated in a cavity of a multi-part rotor shaft;

FIG. 8 and FIG. 9 show a longitudinal sectional representation of an exemplary embodiment of a rotor according to the invention with a structure-borne sound absorbing metal foam integrated in slots of a laminated rotor core;

FIG. 10 shows a longitudinal sectional representation of a part of an electric machine with a rotor shaft, a roller bearing and a housing that forms a bearing seat for the roller bearing;

FIG. 11 and FIG. 12 show a longitudinal sectional representation of a part of an exemplary embodiment of an electric machine according to the invention with a structure-borne sound absorbing metal foam in the region of a bearing seat;

FIG. 13 shows a longitudinal sectional representation of an exemplary embodiment of an electric machine according to the invention with structure-borne sound absorbing metal foam in the region of the bearing seats and in the interior of a multi-part rotor shaft; and

FIG. 14 shows a longitudinal sectional representation of an exemplary embodiment of an electric machine according to the invention with structure-borne sound absorbing metal foam in the interior of a multi-part rotor shaft and in slots of a laminated rotor core.

### DETAILED DESCRIPTION

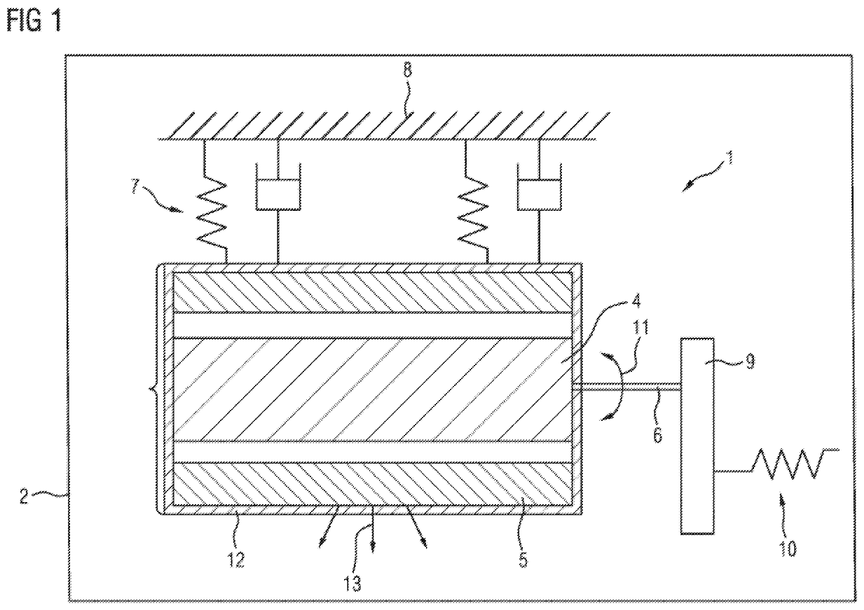

FIG. 1 shows an electric axle drive 1 of a motor vehicle 2. The electric axle drive 1 comprises an electric machine 3 with a laminated rotor core 4, with a stator 5 and with a rotor shaft 6. The stator 5 of the electric machine 3 is coupled to a chassis 8 of the motor vehicle 2 by means of an assembly bearing 7 with springs and dampers. The rotor shaft 6 is coupled to a transmission 9, which is coupled to the vehicle 2 via a transmission bearing 10 with a spring element.

One of the main causes of noises in the electric axle drive 1 is typically the non-uniformity of the torque in the electric machine 3. The non-uniformity of the torque in the electric machine 3 is dependent on the type of construction, and can be influenced by the design of the electric machine 3.

However, the non-uniformity of the torque may also be a result of the activation of the electric machine 3, if for example a switching frequency that is too low and a low leakage inductance in the electric machine 3 produce significant harmonic currents, which can cause torque fluctuations 11, which are often also referred to as “torque ripple”.

The non-uniformity of the torque of the electric machine 3 can contribute to noise generation in various ways. For example, the torque ripple 11 can reach the transmission 9 via the rotor shaft 6 and generate transmission noises there. Furthermore, the torque ripple 11 can reach the chassis 8 of the vehicle 2 via the assembly bearing 7 (if the damping is insufficient) and provide vibration excitation and associated noise. In addition, a housing 12 of the stator 5 (if the dimensions are insufficient) can be excited by the rotating power sources to structure-borne sound 12, which can then take the form of airborne sound.

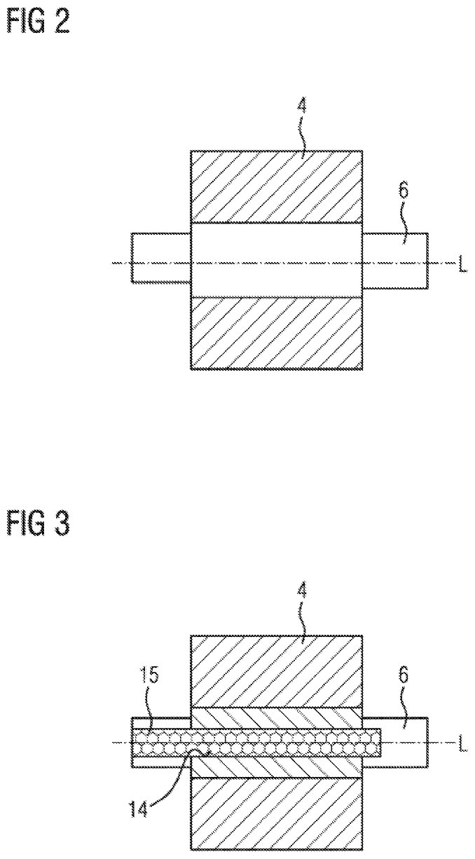

FIG. 2 shows a known rotor with a rotor shaft 6 and with a laminated rotor core 4, which is mounted on the rotor shaft 6 for conjoint rotation.

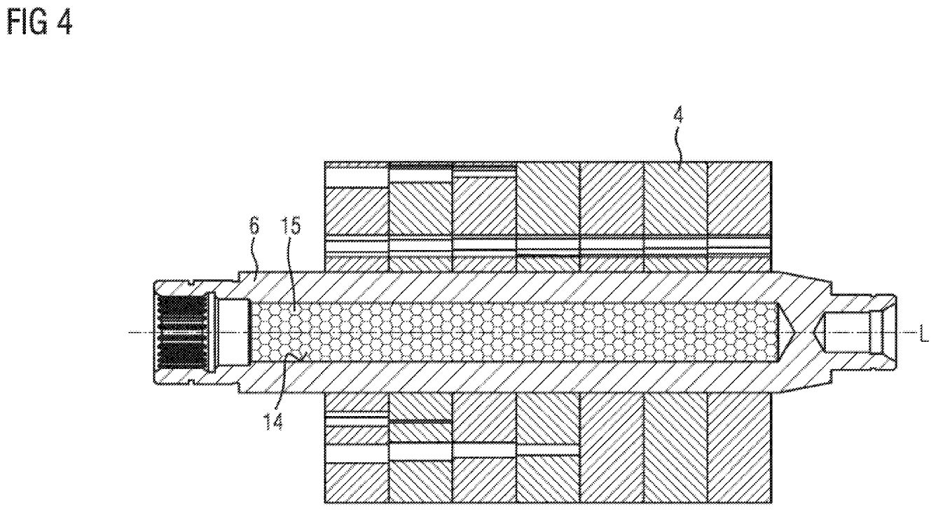

FIGS. 3 and 4 each show a rotor with a rotor shaft 6, which comprises a central bore 14, which extends in a longitudinal direction L of the rotor shaft 6. Arranged within the bore 14 is a structure-borne sound absorbing element 15, which may for example be produced from a metal foam, for example from an aluminum foam.

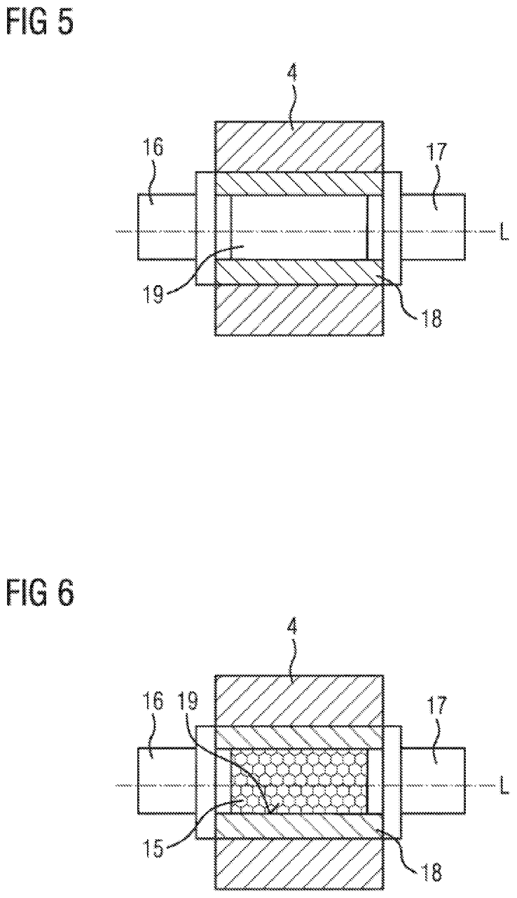

FIG. 5 shows a known rotor, which comprises a first shaft journal 16, a second shaft journal 17, a laminated rotor core 4 (magnetically relevant region) and a carrier 18 for the laminated rotor core 4. The carrier 18 is arranged between the first shaft journal 16 and the second shaft journal 17 in a longitudinal direction L of the rotor. Furthermore, the carrier 18, the first shaft journal 16 and the second shaft journal 17 delimit a cavity 19 between them. Furthermore, the laminated rotor core 4 is mounted on the carrier 18 for conjoint rotation.

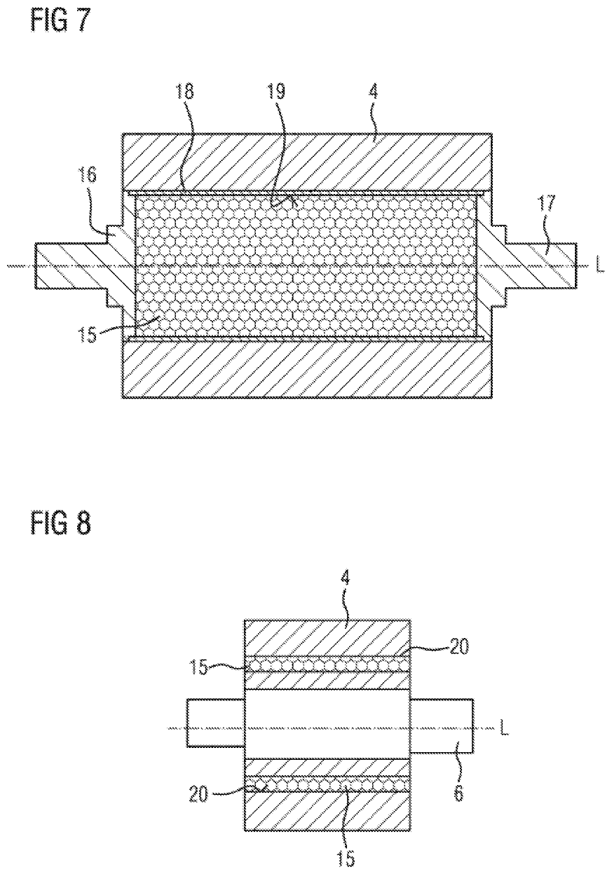

FIGS. 6 and 7 each show a rotor, which has the same basic structure as the rotor shown in FIG. 5. However, a structure-borne sound absorbing element 15 is arranged within the cavity 19 of the rotor as shown in FIGS. 6 and 7, it being possible for the element 15 to be produced for example from a metal foam, for example from an aluminum foam. The structure-borne sound absorbing element 15 may in this case completely fill the cavity 19.

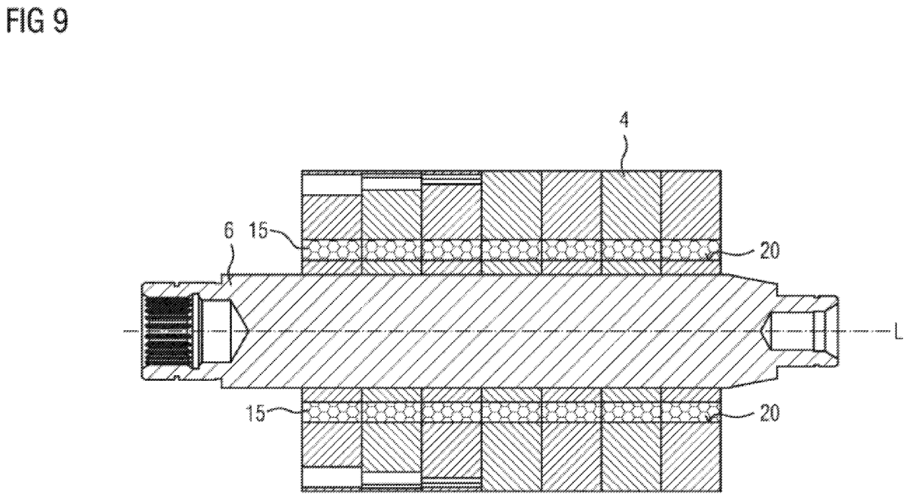

FIGS. 8 and 9 each show a rotor with a rotor shaft 6 and with a laminated rotor core 4, which is mounted on the rotor shaft 6 for conjoint rotation. The laminated rotor core 4 comprises a number of slots 20 distributed in the circumferential direction, which run in the axial direction L through the individual laminations of the laminated rotor core 4. A structure-borne sound absorbing element 15 is arranged in each one of the slots 20. The elements 15 may for example be produced from a metal foam, for example from an aluminum foam. In the exemplary embodiments shown by FIGS. 8 and 9, the slots 20 extend parallel to a longitudinal axis L of the rotor shaft 6.

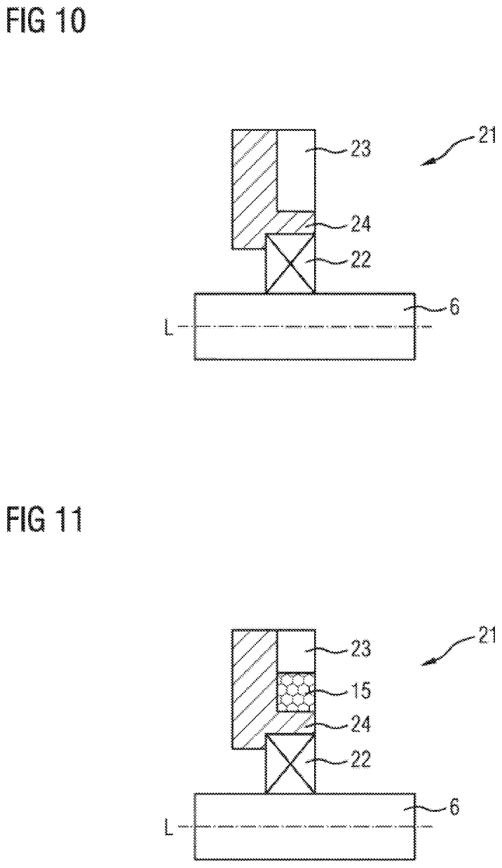

FIG. 10 shows a part of a known electric machine 21 with a rotor shaft 6 and with two roller bearings 22, one of which is shown in FIG. 10. The electric machine 21 may further comprise a housing 23 which forms two bearing seats 24, one of which is shown in FIG. 10. The rotor shaft 6 is rotatably mounted in the two roller bearings 22, and the two bearing seats 24 each receive a roller bearing 22.

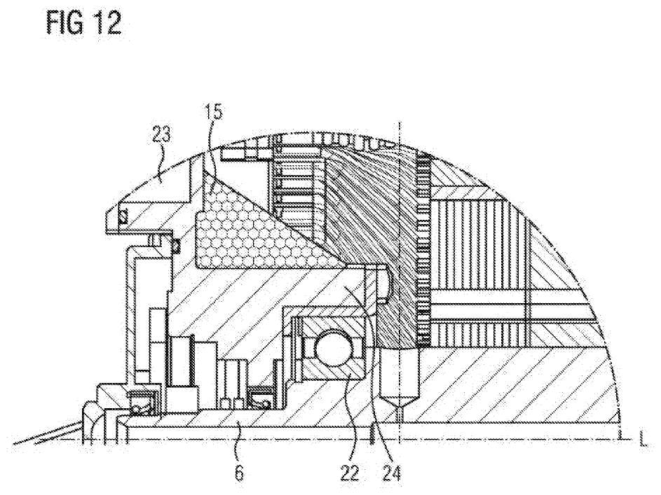

FIGS. 11 and 12 each show a part of an electric machine 21, which has the same basic structure as the electric machine as shown in FIG. 10. However, a structure-borne sound absorbing element 15 made of a cellular metallic material is arranged in the region of the two bearing seats 24 (for example, the element 15 may be molded around the two bearing seats 24), it being possible for the element 15 to be produced for example from a metal foam, for example from an aluminum foam.

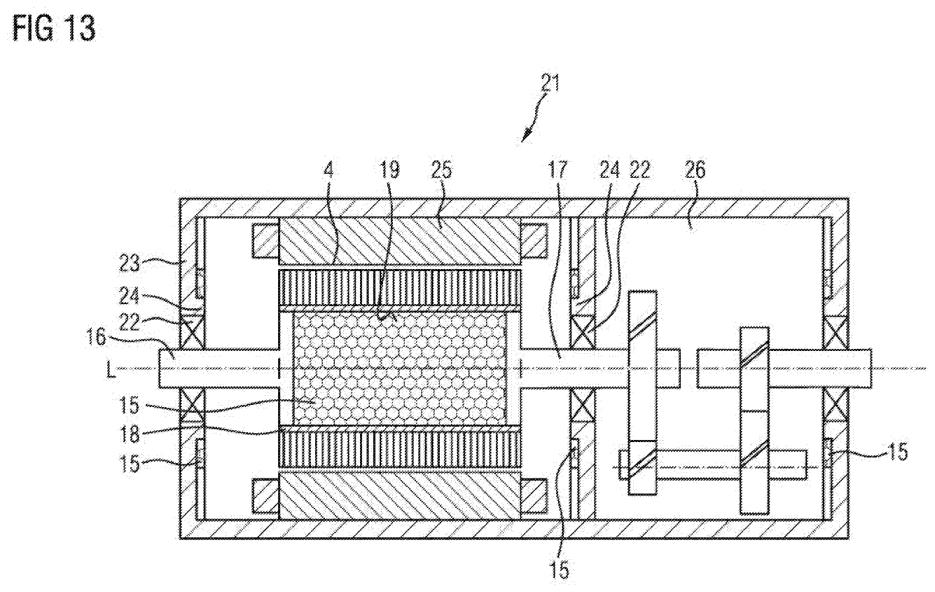

FIG. 13 shows a further electric machine 21. Similarly, as shown in FIGS. 11 and 12, a structure-borne sound absorbing element 15 made of a cellular metallic material is arranged in the region of each of two bearing seats 24. Similarly, as shown in FIGS. 6 and 7, a structure-borne sound absorbing element 15 made of a cellular metallic material is arranged within a cavity 19 of a multi-part rotor, which may comprise a first shaft journal 16, a second shaft journal 17, a laminated rotor core 4 and a carrier 18 for the laminated rotor core 4. The elements 15 may for example be produced from a metal foam, for example from an aluminum foam. According to the exemplary embodiment as shown in FIG. 13, the electric machine 21 may further comprise a stator 25 and a transmission 26 integrated in the electric machine, within which a structure-borne sound absorbing element 15 made of a cellular metallic material may also be arranged.

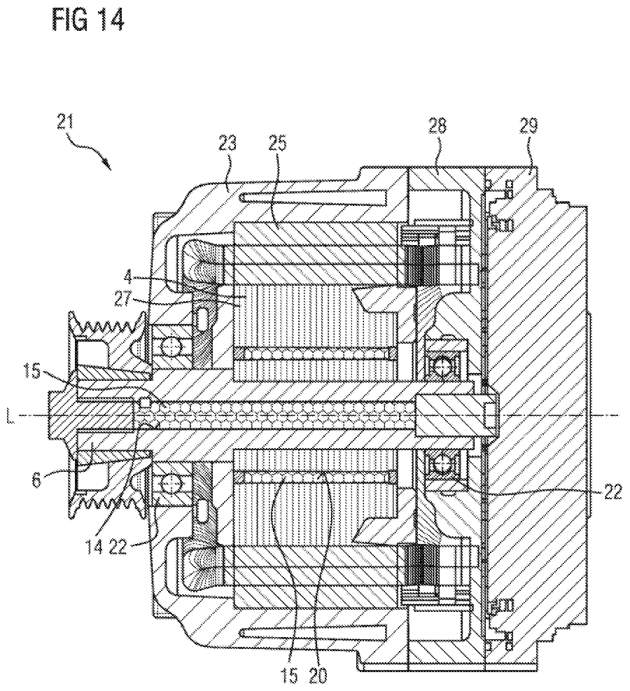

FIG. 14 shows a further electric machine 21. Similarly, as shown in FIGS. 3 and 4, a rotor of the electric machine has a rotor shaft 6 with a central bore 14, which extends in a longitudinal direction L of the rotor shaft 6. A structure-borne sound absorbing element 15 is arranged within the bore 14. Similar to as shown in FIGS. 8 and 9, a laminated rotor core 4 of the rotor comprises a number of slots 20 distributed in the circumferential direction, a structure-borne sound absorbing element 15 being arranged in each one of the slots 20. The elements 15 may for example be produced from a metal foam, for example from an aluminum foam. According to the exemplary embodiment as shown in FIG. 14, the electric machine 21 further comprises a liquid-cooled housing 23, a closure 27 of the laminated rotor core 4, a bearing plate 28 and an inverter 29.

The metal foam shown in the figures described above may comprise hollow spherical structures, for example hollow spherical structures which are filled with, for example with ceramic particles.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

1. A rotor for an electric machine comprising:
at least one structure-borne sound absorbing element made of a cellular metallic material being arranged in the rotor.

2. The rotor as claimed in claim 1, further comprising a rotor shaft with a bore, the structure-borne sound absorbing element being arranged within the bore of the rotor shaft.

3. The rotor as claimed in claim 1, further comprising a laminated rotor core with at least one slot, the structure-borne sound absorbing element being arranged in the slot of the laminated rotor core.

4. The rotor as claimed in claim 1, further comprising:
a first shaft journal;
a second shaft journal spaced apart from the first shaft journal; and
a carrier for a laminated rotor core, the carrier for the laminated rotor core being arranged between the first shaft journal and the second shaft journal, the carrier, the first shaft journal and the second shaft journal delimiting a cavity between them, and the structure-borne sound absorbing element being arranged within the cavity.

5. The rotor as claimed in claim 1, wherein the cellular metallic material is a metal foam.

6. The rotor as claimed in claim 5, wherein the cellular metallic material is an aluminum foam.

7. The rotor as claimed in claim 5, wherein the metal foam comprising hollow spherical structures.

8. The rotor as claimed in claim 7, wherein the hollow spherical structures which are filled with particles

9. The rotor as claimed in claim 8, wherein the hollow spherical structures which are filled with ceramic particles.

10. An electric machine comprising:
a rotor shaft;
two roller bearings;
a bearing seat for each one of the two roller bearings, the rotor shaft being rotatably mounted in the two roller bearings; and
a structure-borne sound absorbing element made of a cellular metallic material being arranged in the region of at least one of the two bearing seats.

11. The electric machine as claimed in claim 10, wherein the cellular metallic material being a metal foam.

12. The electric machine as claimed in claim 11, wherein the metal foam is an aluminum foam.

13. The electric machine as claimed in claim 11, wherein the metal foam comprises hollow spherical structures.

14. The electric machine as claimed in claim 13, wherein the hollow spherical structures are filled with particles.

15. The electric machine as claimed in claim 14, wherein the hollow spherical structures are filled with ceramic particles.
